(19) United States
(12) Patent Application Publication
(10) Pub. No.: US 2024/0205072 A1
(43) Pub. Date: Jun. 20, 2024

(54) APPARATUS AND METHOD FOR LOCATING FAULTS IN ETHERNET RING NETWORKS

(71) Applicant: Honeywell International Inc., Charlotte, NC (US)

(72) Inventors: Siyun Zhou, Shanghai (CN); Changqiu Wang, Shanghai (CN); Wei Dai, Shanghai (CN); Baiqing Wu, Shanghai (CN)

(73) Assignee: Honeywell International Inc., Charlotte, NC (US)

(21) Appl. No.: 18/124,965

(22) Filed: Mar. 22, 2023

(30) Foreign Application Priority Data
Dec. 15, 2022 (CN) 202211615311.X

(51) Int. Cl. H04L 41/0659; H04L 12/54

(52) U.S. Cl. CPC H04L 41/0659; H04L 12/5601; H04L 2012/5604; H04L 2012/5612

(57) ABSTRACT

An apparatus and method comprising a memory containing a fault detection program and a processor operably connected to the memory and to a communication network. The communication network is connected to a plurality of processing devices through at least one communication port. The processor is configured to execute the fault detection program to send status requests on the communication network requesting the operational status of the communication port from each processing device and to receive the operational status of the communication port from each processing device. The fault detection program analyzes the received operational status of the communication ports to isolate faults in the communication network between two of the processing devices.

### CROSS-REFERENCE TO RELATED APPLICATION AND PRIORITY CLAIM

This application claims priority under 35 U.S.C. § 119 to Chinese Patent Application No. 202211615311.X filed on Dec. 15, 2022. This patent application is hereby incorporated by reference in its entirety.

### TECHNICAL FIELD

This disclosure is generally directed to industrial process control and automation systems. More specifically, this disclosure is directed to an apparatus and method for identifying the location of faults in Ethernet ring networks causing failures in gateway or edge nodes.

### BACKGROUND

Modern industrial process control and automation systems are typically equipped with a considerable number of field devices which monitor and control the manufacture process during the operation of a manufacturing plant. For example, field devices monitor signals such as temperatures and pressure and a variety of software performance metrics relating to the process being controlled by the industrial process control and automation system. Signals provided by the field devices are used by various process controllers of the automation system to control actuators to adjust various process parameters to control the manufacturing process. Industrial process control and automation systems can use Ethernet based industrial networks to communicate control and data signals between field devices and controllers of the automation system. The industrial Ethernet networks are connected in various network topologies, such as for example, ring and linear/star Ethernet networks and may use various data communication protocols, such as for example, EtherNet/IP and or a Profinet protocols used in managed communications between the field devices and the controllers. In unmanaged Ethernet ring networks, an input/output IO protocol such as for example, a MODBUS protocol or an open DNP3 protocol may be used to communication between the field devices and a remote terminal unit (RTU) controller.

There are no currently known methods that can detect and pinpoint the communication failures in ring networks caused by mis-connected, broken wiring, or connector/extender shorting, between a controller and IO modules connected to an unmanaged Ethernet ring network. There is a need in industry for a pro-active mechanism that can detect and diagnose network instabilities between an RTU controller in an unmanaged Ethernet ring network to locate the location of the fault in the ring network in order to repair the fault.

### SUMMARY

This disclosure relates to an apparatus and method for identifying the location of faults in Ethernet ring networks causing failures in gateway or edge nodes.

In a first embodiment, an apparatus is used to locate faults in a communication network connected to a plurality of processing devices each having at least one communication port. A memory contains a fault detection program and a processor operably connected to the memory and to the communication network is configured to execute the fault detection program to send status requests to each communication port to request its operational status. The fault detection program receives the operational status of the communication ports and analyzes each communication ports operational status to isolate the faults in the communication network between two of the processing devices.

In a second embodiment a method is disclosed that includes a communication network connected to a plurality of processing devices through a communication port. The method comprises sending status requests on the communication network requesting the operational status of the communication port of each processing device. The method further includes receiving the operational status of the communication port from each of the plurality of processing devices and analyzing the operational status of each communication port to isolate faults in the communication network between two processing devices.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial control and automation system according to this disclosure;

FIG. 2 illustrates an example RTU controller according to this disclosure;

FIG. 3 illustrates an example Ethernet ring network according to this disclosure;

FIG. 4 illustrates the example Ethernet ring network of FIG. 3 configured to analyze a fault in the network; and

FIG. 5 illustrates an example method used to analyze device communication failures in communication networks according to this disclosure.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

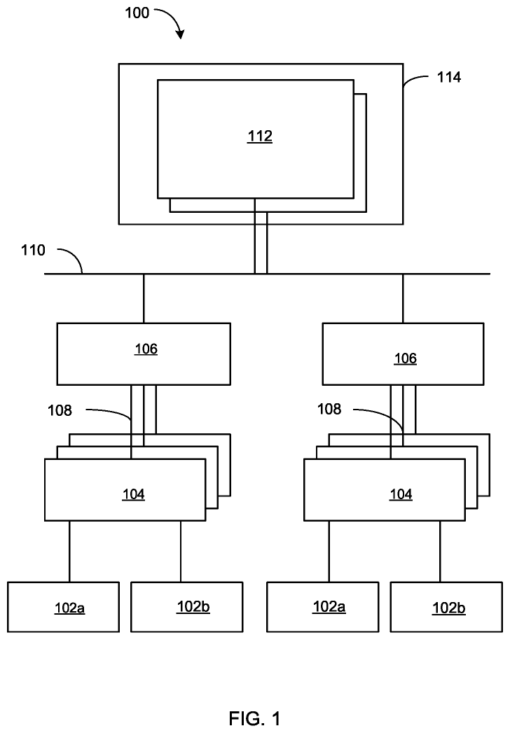

FIG. 1 illustrates a portion of an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, a I/O module 104 could include fixed number(s) and type(s) of inputs or outputs or reconfigurable inputs or outputs. In the exemplary system of FIG. 1 I/O modules 104 are connected to controllers 106 via a communication network 108. The controllers 106 serve as an entry and exit point for a device node. Control information as well as data must pass through or communicate with the controller 106 prior to being routed from the node. For example, control information from a controller 106 can be sent to one or more actuators 102a associated with the controllers 106 node. Data from the sensors 102a is communicated to one or more controllers 106 associated with the node.

A first set of controllers 106 may use measurements from one or more sensors 102a to control the operation of one or more actuators 102b. These controllers 106 could interact with the sensors 102a, actuators 102b, and other field devices via the I/O module(s) 104. The controllers 106 may be coupled to the I/O module(s) 104 via Ethernet, backplane communications, serial communications, or the like. A second set of controllers 106 could be used to optimize the control logic or other operations performed by the first set of controllers. A third set of controllers 106 could be used to perform additional functions.

The controllers 106 can be used in the system 100 to perform various functions in order to control one or more industrial processes. For example, a first set of controllers 106, that operate as a first network node may use measurements from one or more sensors 102a sent from controllers 106 operating as a second and separated network node to control the operation of one or more actuators 102b. These controllers 106 could interact with the sensors 102a, actuators 102b, and other processing devices singularly or via multiple I/O module(s) 104.

The controllers 106 may be coupled to the I/O module(s) 104 via the network 108 using various network topologies, such as for example, a ring topology, a linear bus topology or star topology or any combination of ring, star or linear or the like. A second set of controllers 106 could be used to optimize the control logic or other operations performed by the first set of controllers within a network node.

The network 108 can use a managed industrial Ethernet application layer for industrial automation, such as for example, an Ethernet industrial (EtherNet/IP) protocol or a process field net (Profinet) protocol to communicate between the controller and devices connected to the device network 108. Such managed industrial Ethernet application layers use all the transport and control protocols used in a traditional Ethernet system including the Transport Control Protocol (TCP), the user datagram protocol (UDP), the internet protocol (IP) and the media access and signaling technologies found in off-the-shelf Ethernet interfaces and devices. It allows the user to address a broad spectrum of process control needs using a single technology. EtherNet/IP is currently managed by the Open DeviceNet Vendors Association (ODVA) and Profinet by the Profibus international organization.

Both the managed Ethernet protocols use a comprehensive suite of messages and services for a variety of manufacturing automation applications, including control, safety, synchronization, motion, configuration, and information. Controllers 106 and compatible Ethernet devices installed on an EtherNet/IP network can communicate with other EtherNet/IP compliant devices connected on an EtherNet/IP network. Profinet compliant devices connected on Profinet network can communicate with other Profinet compliant devices connected on the Profinet network. Data accessed from devices connected to a managed industrial ethernet protocol (reads and writes) can be used for control and data collection.

The network 108 may also use an unmanaged industrial Ethernet protocol such as for example, a MODBUS protocol or an open DNP3 protocol to communicate between the controller and the devices connected to the network 108. Specifically, the MODBUS and DNP3 communication protocols are used to communicate control and data between a remote terminal unit (RTU) controller 106 and the sensors 102a and 102b connected to IO modules 104. The RTU controller 106 is a microprocessor based computing device that is capable of remotely monitoring and controlling the field devices 102a and 102b connected to the RTU controller 106. The RTU controller 106 is also capable of communicating data and sensor information to and receiving control information from an industrial process control and automation system or a supervisory control and data acquisition SCADA system. The RTU controller 106 is considered self-contained, as it has all the basic parts that, together, define a computer system such as a processor, a memory and communication interface. Because of this, it can be used as an intelligent controller or master controller for devices that, together, automate a process for the control of one or more aspects of an industrial process, such as for example, an edge controller used in a network node for controlling specific portions of an industrial process.

Operator access to and interaction with the any controller 106, in system 100 including an RTU controller 106 can occur via various operator stations 112 coupled to controllers 106 via a plant wide Ethernet network 110. An operator station 112 can be located in a control room 114 that controls a plant or enterprise or may be coupled or assigned locally to a controller 106 that could receive and display warnings, alerts, or other messages or displays generated by a particular controller 106 or set of controllers.

Each operator station 112 could be used to provide information to an operator and receive information from an operator. For example, each operator station 112 could provide information identifying a current state of an industrial process to an operator, such as values of various process variables and warnings, alarms, or other states associated with the industrial process. Each operator station 112 could also receive information affecting how the industrial process is controlled, such as by receiving setpoints for process variables controlled by the controllers 106 or other information that alters or affects how the controllers 106 control the industrial process. Each operator station 112 includes any suitable structure for displaying information to and interacting with an operator. Each of the operator stations could, for example, represent a computing device running a MICROSOFT WINDOWS operating system.

This represents a brief description of one type of industrial process control and automation system that may be used to manufacture or process one or more materials. Additional details regarding industrial process control and automation systems are well-known in the art and are not needed for an understanding of this disclosure. Also, industrial process control and automation systems are highly configurable and can be configured in any suitable manner according to particular needs.

Although FIG. 1 illustrates a portion of one example industrial process control and automation system 100, various changes may be made to FIG. 1. For example, various components in FIG. 1 could be combined, further subdivided, rearranged, or omitted and additional components could be added according to particular needs. FIG. 1 further illustrates one example of an operational environment used by RTU controllers in an unmanaged Ethernet device network. The ring fault diagnostic of the present disclosure could also be used with redundant automation controller or RTU controllers in any other suitable system.

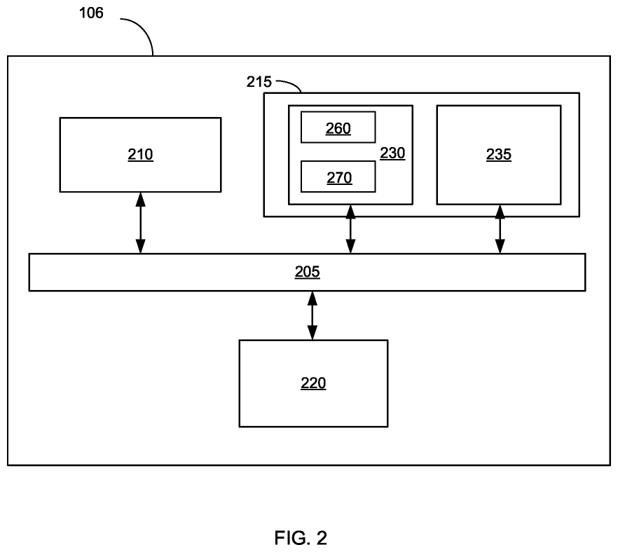

FIG. 2 illustrates an example of an RTU controller 106 according to this disclosure. As shown in FIG. 2, the controller 106 includes a bus system 205, which supports communication between at least one processor 210, at least one storage device 215, and at least one communications unit 220.

The processor 210 executes instructions that may be loaded into a memory 230. The processor 210 may include any suitable number(s) and type(s) of processors or other devices in any suitable arrangement. Example types of processor 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, applications and/or other suitable information on a temporary or permanent basis). In the present disclosure memory 230 of RTU controller 106 stores an IO manager 260 application that is executed by the processor 210 and used for locating faults in the network 108. The memory 230 may also contain a platform communication program 270 used to send fault information from the IO manager to operator station 112 for display to a user. The memory 230 may represent a random access memory or any other suitable volatile or non-volatile storage device(s). The persistent storage 235 may contain one or more components or devices supporting longer-term storage of data, such as a ready only memory, hard drive, flash memory, or optical disc.

The communications unit 220 supports communications with other systems or processing devices. For example, the communications unit 220 could include an Ethernet network interface card for communication over network 108 and plant network 110 or a wireless transceiver facilitating communications over a wireless network (not shown). The communications unit 220 may support communications through any suitable physical or wireless communication link(s).

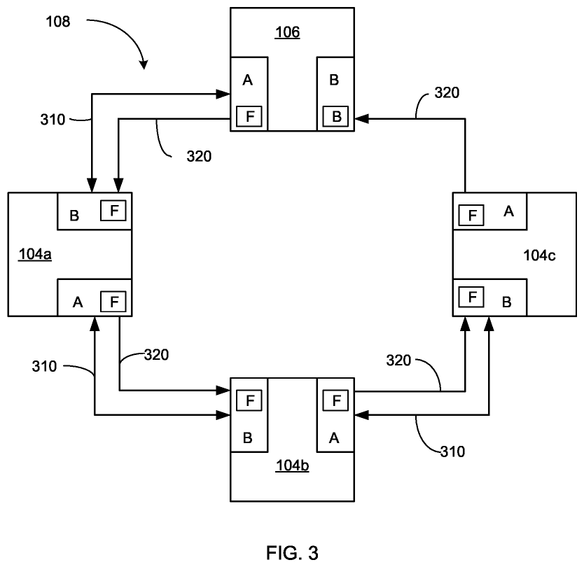

FIG. 3 illustrates an example of an unmanaged Ethernet device network 108 consisting of processing devices such as for example, an RTU controller 106 connected via Ethernet cables to IO modules (IOM) 104a, 104b, and 104c in a ring network topology. Each IOM 104a, 104b and 104c may represent a device node that connects to one or more sensors 102a or actuators 102b. Each IOM 104a-104c receives data from its connected sensors 102a and sends control signals to its connected actuators 102b. The RTU controller 106 acts as a node master for each of the connected node 1OMs 104a-104c.

It should be noted that the present disclosure is intended to be used in Ethernet networks configured in a ring network topology. In the following description the use of the term network signifies an Ethernet network configured in a ring network topology. In FIG. 3, each processing device connected to network 108 includes at least a two-port Ethernet switch for forwarding and receiving data and control signals between the processing devices connected to the network 108. The Ethernet two-port switch may be for example a stand-alone device or contained as an integrated unit within the RTU controller 106 and in each IOM 104a-104c. For this disclosure, the Ethernet switch is shown contained within its respective processing device. Each Ethernet switch includes an A and B port that communicatively connects each processing device in network 108 to the other via an Ethernet cable.

In the network 108 illustrated in FIG. 3, each port A or B may be connected to the next port of the next processing device without adhering to a same port to port connection. For example, an Ethernet cable may connect port A of RTU controller 106 to port B of IOM 104a. While port A of IOM 104a may be connected to port B of IOM 104b and so on. Data and control signals are broadcast on network 108 as data packets addressable to an IOM 104a-104c from the RTU controller 106. Similarly, each IOM 104a-104c may send data packets to from each IOM 104a-104c to the RTU controller 106. Each port A or port B of each device may also have their ports A or B switched to forward, designated by the letter “F” the data packets from IOMs 104a-104c and RTU controller 106 or blocked, designated by the letter “B” from being passed along to the next processing device in the network 108.

A shown in FIG. 3, data packets are sent by the RTU controller 106 to the IOM 104a-104c connected to network 108 along a bi-directional communication path 310 as a downlink from port A of the RTU controller 106. Similarly, each IOM 104a-104c can uplink data packets from each IOM to the RTU controller 106 through either of its ports A or B along bi-directional path 310. The RTU controller 106, also broadcasts bridge protocol data unit (BPDU) data packets to each IOM 104a-104c along uni-directional communication path 320. The BPDU packet is a data message transmitted to all the processing devices connected to the network 108 that functions to detect loops in network topologies. A BPDU data message contains information regarding ports, switches, port priority and addresses for the network 108. The BPDUs message enables the RTU controller 106 to gather information about each of the Ethernet switches used in the network 108. The absence of a return BPDU packet to the RTU controller 106 would indicate a fault in network 108, such as for example a broken Ethernet cable, or a faulty Ethernet switch.

The present invention discloses an apparatus and method for locating the position of where within the network ring a fault has occurred that has disrupted communication on the network 108. When a ring fault is detected by the RTU controller 106, the RTU controller 106 sends diagnostic messages to each IOM 104a-104c in the network 108 requesting the status of each of the IOMs Ethernet ports. The RTU controller 106 uses the port status data to identify the fault edge node experiencing the loss in communication.

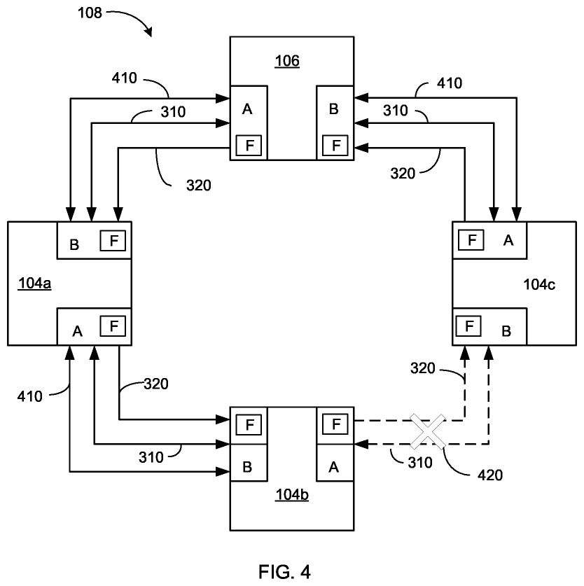

FIG. 4 illustrated the ring network 108 shown in FIG. 3, having the Ethernet cable connecting port A of IOM 104b broken or disconnected from port B of IOM 104c. The broken cable is illustrated by the “X” 420. The loss of communication between IOM 104b and 104c is illustrated by the broken lines. As is illustrated in FIG. 4, a broken cable would lead to loss of the BDPU path 320 and the data path 310. Loss of the BDPU path 320 between IOM 104b and 104c would prevent the BDPU packet from being returned to the RTU controller 106. Therefore a BDPU packet would not be transmitted along BDPU path 320 between IOM 104c and the RTU controller 106. Upon detection by the RTU controller 106 of the loss of the BPDU packet the RTU controller 106 switches its port B switch from “B” (blocking), to “F” (forward), to allow data communications to IOM 104c from the RTU controller 106. A diagnostic program is then executed by the RTU controller 106 to isolate the fault edge node in the network 108. Diagnostic packets from the IO manager 260 are downlinked from the controller 106 from both RTU controller 106 ports A and B to the network 108, as illustrated by diagnostic path 410. The diagnostic packets requesting the status of the ports A and B of each Ethernet switch connected to the ring network.

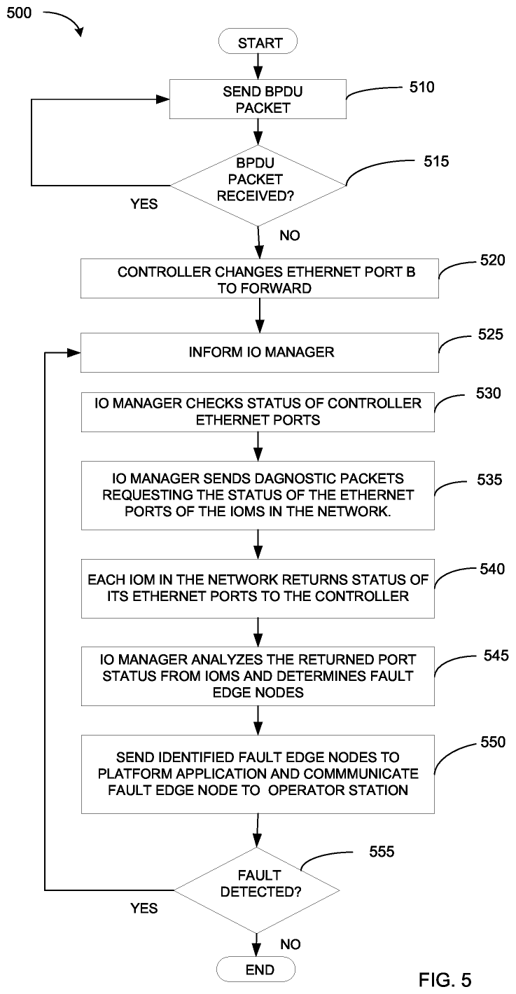

FIG. 5 illustrates the method used by the present disclosure to isolate a detected fault in the network 108. In step 510 and as was explained earlier, the RTU controller 106 sends a BPDU packet down the network 108 from port A and of its Ethernet switch and listens for its return at port B. If the BPDU packet is returned in step 515 the RTU controller 106 branches back to step 510 and sends another BPDU packet to the network 106. It should be noted that the RTU controller 106 may also wait a set amount of time before resending the BPDU packet.

If the RTU controller 106 at step 515 fails to receive the BPDU packet, the RTU controller resets the RTU controller 106 port B to “F” (forward) from “B” (blocking) in step 520 establishing a path to the RTU controller 106 for bi-directional communication of data packets along path 310 between IOM 104c and RTU controller 106. Next in step 525 the IO manager is informed of a possible fault in the network 108 and the IO manager application 260 is executed by processor 210 to run the fault detection program. Next in step 530 the RTU controller 106 checks the status of its own Ethernet ports A and B and establishes if its ports are in a good status or a bad status.

In step 535 the IO manger 260 broadcasts diagnostic packets to the IOMs 104a-104c requesting the status of their Ethernet switch ports. Each IOM 104a-104c returns the status of its Ethernet ports via diagnostic path 410 to RTU controller 106 and the IO manager 260 in step 540. Each IOM 104a-104c sends data representing if its Ethernet ports are in a good or bad status. A bad status would represent a port failure caused by a hardware problem such as bent, broken or bent cable or improper connection causing a communication failure at the port. It may also represent a software or other operational failure with the IOM, controller or the Ethernet switch associated with each processing device. A good status represents that the port is operating normally.

In step 545 the IO manager analyzes the returned diagnostic data and determines where in the network the fault edge node is located. For the example in FIG. 4, the RTU controller 106 would send that both its ports A and B are in a good status, IOM 104a would report that both its ports A and B are in a good status, IOM 104b would report that its port A is in a bad status and its port B in a good status and for IOM 104c port A is in a good status and port B is in a bad status. The IO manager than summarizes that the fault lies between IOM 104b port A and IOM 104c port B and therefore IOM 104b and 104c are the fault edge nodes. When the fault edge nodes are identified by IO manager 260, platform program 270 is executed by the processor 210 in step 550 to communicate the diagnostic data gathered by the IO manager 260. The platform program 270 sends notification and the diagnostic data, including the fault edge nodes to the operator station 112 via the plant network 110 for display to a plant operator or a network technician. The network technician can then be dispatched to the fault edge nodes to investigate the cause of the fault and repair it.

The I/O manager 260 will be executed continuously until there is no fault in the network 108 as shown in step 555. This enables dynamically updating the fault position in the network 108 and the fault edge nodes if the fault is extended or another fault has occurred.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. An apparatus for isolating a fault in a communication network comprising:
a plurality of processing devices having at least one communication port connected to the communication network;
a controller connected to the plurality of processing devices and to the communication network, wherein the controller acts as an entry and exit point for the communication network;
a memory containing a fault detection program;
a processor operably connected to the memory and the communication network, the processor configured to execute the fault detection program to:
request an operational status of the at least one communication port of each of the plurality of processing devices by sending a status request to each of the plurality of processing devices via the communication network;
receive the operational status of the at least one communication port from each of the plurality of processing devices; and
isolate, based on the received operational status of the at least one communication port, the fault in the communication network between two processing devices of the plurality of processing devices.

2. The apparatus of claim 1, wherein the processor is further configured to:
send a bridge protocol data unit (BPDU) message on the communication network; and
activate the fault detection program when the BPDU message is not returned to the processor.

3. The apparatus of claim 1, wherein the memory and the processor comprise the controller.

4. The apparatus of claim 3, wherein the communication network is an unmanaged Ethernet network communicatively connecting the controller and the plurality of processing devices using Ethernet cables in a ring network topology.

5. The apparatus of claim 4, wherein the plurality of processing devices comprise:
IO modules connected to sensors and actuators of an industrial process, and each IO module and the controller is connected to an associated Ethernet switch having at least a first and a second communication port connected to the Ethernet cables,
wherein the fault detection program isolates the fault in the ring network topology between the at least first and the second communication ports of the Ethernet switches connected between two IO modules or between the at least first and the second communication ports of the Ethernet switch connected between an IO module and the controller.

6. The apparatus of claim 5, wherein the apparatus includes an operator display and the controller includes a platform program stored in the memory for sending notifications and diagnostic data to an operator station of a location of the fault in the ring network topology.

7. (canceled)

8. The apparatus of claim 3, wherein the controller is a remote terminal unit (RTU).

9. The apparatus of claim 3, wherein the controller is an edge controller used in the communication network for controlling specific portions of an industrial process.

10. The apparatus of claim 2, wherein the BPDU message contains information regarding port priority and addresses for communication ports of Ethernet switches for the communication network.

11. The apparatus of claim 5, wherein absence of a return BPDU message to the controller indicates the fault in the communication network.

12. The apparatus of claim 11, wherein the indicated fault is a broken ethernet cable.

13. The apparatus of claim 11, wherein the indicated fault is a faulty Ethernet switch.

14. A method for isolating a fault in a communication network connected to a plurality of processing devices each having at least one communication port comprising:
requesting an operational status of the at least one communication port of each processing device by sending a status request to each of the plurality of processing devices via the communication network, wherein the plurality of processing devices and the communication network are connected to a controller, and wherein the controller acts as an entry and exit point for the communication network;
receiving the operational status of the at least one communication port of each of the plurality of processing devices; and
isolating, based on the received operational status of the at least one communication port, the fault in the communication network between two processing devices of the plurality of processing devices.

15. The method of claim 14, the method further comprising:
sending a bridge protocol data unit (BPDU) message from the controller to the plurality of processing devices on the communication network; and
sending the status requests when the BPDU message is not returned to the controller.

16. The method of claim 15, wherein the communication network is an unmanaged Ethernet network communicatively connecting the controller and the plurality of processing devices using Ethernet cables in a ring network topology, the method further comprising:
connecting each processing device and the controller to an associated Ethernet switch having at least a first and a second communication port, each first and second communication port connected to the Ethernet cables,
wherein the step of isolating isolates the fault in the ring network topology between the at least first and the second communication ports of the Ethernet switch connected between two IO modules.

17. The method of claim 16, wherein the step of isolating isolates the fault in the ring network topology between the at least first and the second communication ports of the Ethernet switch connected between an IO module and the controller.

18. The method of claim 16, wherein the controller is connected to an operator display and the controller sends notifications and diagnostic data to an operator station of the isolated fault in the ring network topology.
